(19) United States
(12) Patent Application Publication
(10) Pub. No.: US 2023/0267501 A1
(43) Pub. Date: Aug. 24, 2023

(54) METHOD AND APPARATUS FOR DELAYED IMPRESSION PREDICTION

(71) Applicant: Comcast Cable Communications, LLC, Philadelphia, PA (US)

(72) Inventors: James Lubowsky, Hillsdale, NJ (US); Joshua Wang, New York, NY (US); Gil Cukierman, Jersey City, NJ (US); Benjamin Landrum, Collingswood, NJ (US); Jia Ni, Syosset, NY (US)

(21) Appl. No.: 17/675,689

(22) Filed: Feb. 18, 2022

(51) Int. Cl. G06Q 30/02; G06Q 30/08

(52) U.S. Cl. CPC G06Q 30/0251; G06Q 30/08

(57) ABSTRACT

Methods and systems are described for dynamically managing resources when submitting bids for advertising content opportunities. The system may determine whether a bid request is likely to be accepted or rejected, or whether an impression event associated with an impression from a bid associated with the bid request is delayed by a time duration. The system may determine, based on information associated with a bid request, a plurality of features associated with the bid request. Each feature of the plurality of features may be associated with one or more distributions indicating a percentage likelihood that the that the impression from the bid associated with the bid request is delayed by the time duration, or whether a bid is likely to be rejected or accepted. The selected features may be based on the impact the features have on indicating whether a bid is likely to be accepted or rejected or result in a delayed impression.

### BACKGROUND

Advertisers and inventory holders may bid on advertising inventory via digital advertising exchanges. During the life cycle of a bid, advertisers and inventory holders attempt to manage available resources for future bids and maintain established budget constraints. However, this may become difficult when results from already-placed but unresolved bids are delayed. For example, there may be a delay in obtaining an indication (e.g., an advertising impression) as to whether a bid has been accepted, thus leaving uncertainty as to remaining resources.

Accordingly, there is a need for improved techniques for managing advertising resources when transacting with a digital advertising exchange.

### SUMMARY

This Summary is provided to introduce concepts that are further described herein. This Summary is not intended to be used to limit the scope of the claimed subject matter.

Methods and systems are described for dynamically managing resources when determining advertising content impression opportunities. The system may determine whether a submitted bid for an advertising slot or opportunity is likely to be accepted or rejected or whether an impression from a winning bid associated with the bid request is delayed by a time duration. The system may determine, based on information associated with a bid request, a plurality of features associated with the bid request. The plurality of features may comprise at least one or more of: information associated with a target audience such as geographic or demographic information, a device type of a computing device processing, delivering, and/or presenting advertising content associated with the bid request, an inventory source, a placement type, an application bundle, or other features. Each feature of the plurality of features may be associated with one or more distributions indicating a likelihood (e.g., a percentage) that the bid request will be accepted, will be rejected, or that the impression from the winning bid associated with the bid request will be delayed by a time duration, or another outcome. The selected features may be based on execution of one or more scripts that output one or more indications of which features impact whether a bid request will be accepted or rejected or whether an impression event will be delayed. The plurality of features may be organized in a tree structure with each level of the tree conditioning the distributions on an additional feature of the bid request.

For example, the system may predict, based on the plurality of features and stored information, that the impression from the winning bid associated with the bid request is delayed by the time duration. The stored information may comprise historical data associated with at least one of: an inventory source, a device type of a computing device presenting advertising content, a target audience, an inventory source, a placement type, or an application bundle. The delayed impression may comprise an impression event that is triggered after a time duration in which every bid is considered a winner (e.g., an inflight window) expires. The system may cause output of resource data indicative of remaining resources (e.g., budget) after the delayed impression. The remaining resources may indicate that an allocated budget less a consumed budget, less an inflight budget, and less a delayed impression budget is greater than an amount for the bid request.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example system;

FIG. 2 shows an example system;

FIG. 3 shows an example feature tree categories;

FIG. 4 shows an example feature tree associated with a bid request;

FIG. 5 shows an example method;

FIG. 6 shows an example method;

FIG. 7 shows an example method; and

FIG. 8 shows an example computing device.

### DETAILED DESCRIPTION OF ILLUSTRATIVE EMBODIMENTS

Methods and systems are described for dynamically managing resources when determining advertising content impressions. The techniques described herein may be applied by advertisers for placing bids on the presentation of future advertisements to users of various computing devices. Advertisers may predict delayed impressions associated with those advertisements. Advertisers may predict whether a bid is accepted or rejected.

Managing available resources may become difficult when results from already-placed bids are delayed. For example, there may be a delay in obtaining an indication (e.g., an advertising impression) as to whether a bid has been accepted, thus leaving uncertainty as to remaining resources. A delayed impression is an impression that is triggered after an inflight window expires. As used herein, an inflight window is a time duration in which every bid is considered a winner. For example, the inflight window may be 30 seconds. For example, an advertiser may bid on advertising inventory (e.g., an advertisement placement opportunity or an ad avail) if the advertiser's allocated budget less their consumed budget and less their inflight budget is greater than the amount for the bid. For example, the advertiser may bid if the below equation is satisfied:

Allocated Budget−Consumed Budget−Inflight>Bid Amount Equation (1)

Delayed impressions can lead to spending when there is no more available budget because they are triggered after the inflight budget expires, and therefore are not accounted for in Equation (1). To prevent overspending, an advertiser wants to bid if:

Allocated Budget−Consumed Budget−Inflight−Delayed Impressions>Bid Amount Equation (2)

Accounting for delayed impressions requires information about the future delayed impressions. The techniques described herein use a prediction model that may be used to predict how long it will take to receive an impression. The prediction model may analyze a previous day's data to predict a number of delayed impressions. For example, the model may determine the distribution of time between an impression and the bidding cycle. The prediction model that may be used to predict whether a bid request will be accepted or rejected and use that prediction to further compute budget as defined herein.

The prediction model may analyze features of a placed bid. Based on the features of the bid request, the prediction model may determine which features impact whether an impression is likely to be accepted, rejected, or delayed. For example, based on the analyzed features, the model may predict a time duration for receiving an impression associated with the bid. As a result, the prediction model may predict delayed impressions and therefore provide more accurate, real-time information about available resources (e.g., available budget) to an advertiser. For example, based on the analyzed features, the model may predict whether the bidder may expect the bid to be accepted or rejected. As a result, the prediction model may predict accepted/rejected bids and therefore provide more accurate, real-time information about available resources (e.g., the available budget) to an advertiser.

The features may comprise bid parameters associated with the bid request submitted by the advertiser. The features may be determined, for example, based on populated fields in the bid request or based on metadata or other information associated with the bid request. The features may comprise bid parameters including but not limited to: a device type of the device playing back the advertisement, an inventory source, a placement type, or an application bundle. The inventory source may be determined, for example, based on based on metadata or other information associated with the bid request. An application bundle as used herein may refer to a unique identifier associated with an application in which advertising content is served. The predicted time duration may indicate that the impression will be a delayed impression. A feature tree may be constructed to determine which distribution to use.

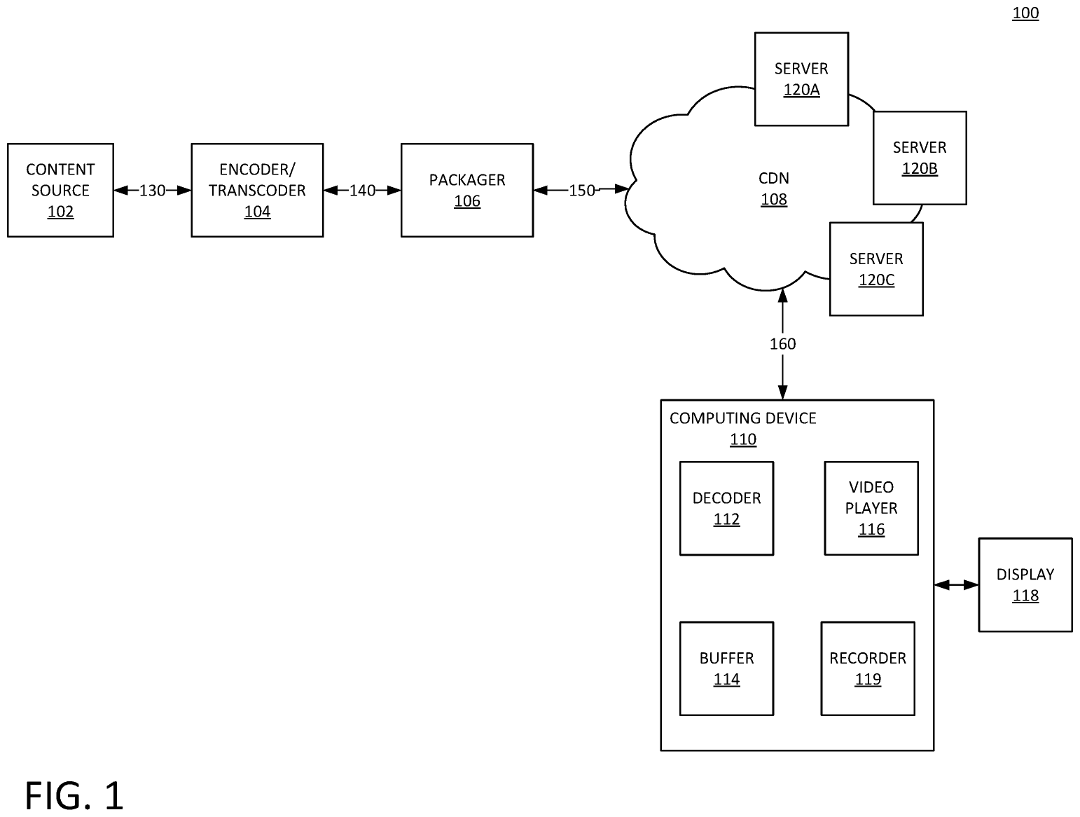

FIG. 1 shows system 100 for delivering content. The example system 100 may comprise a content source 102, an encoder/transcoder 104, a packager 106, a content delivery network (CDN) 108, and a computing device 110. The techniques for content delivery described herein are applicable to any content delivery method including but not limited to Dynamic Adaptive Streaming over HTTP (DASH), HTTP Live Streaming (HLS), the quadrature amplitude modulation (QAM) standard, and/or adaptive bit rate (ABR) streaming.

The computing device 110 may comprise a television, a monitor, a laptop, a desktop, a smart phone, a set-top box, a streaming-video player, a cable modem, a gateway, a tablet, a wearable computing device, a mobile computing device, any computing device configured to receive and/or render content, the like, and/or any combination of the foregoing. The computing device 110 may comprise a decoder 112, a buffer 114, a video player 116, and a digital video recorder (DVR) 119. The computing device 110 (e.g., the video player 116) may be communicatively connected to a display 118. The display 118 may be a separate and discrete component from the computing device 110, such as a television display connected to a set-top box. The display 118 may be integrated with the computing device 110. The decoder 112, the video player 116, the buffer 114, the DVR 119, and the display 118 may be realized in a single device, such as a laptop or mobile device. The decoder 112 may decompress/decode encoded video data. The encoded video data may be received from the encoder/transcoder 104, the packager 106, or the CDN 108.

The content source 102 may comprise a source feed of content from a provider. For example, the content source 102 may comprise a broadcast source, a service provider (e.g., a cable television service provider), an advertiser, a headend, a video on-demand server, a cable modem termination system, the like, and/or any combination of the foregoing. The content source 102 may send content 130 to the encoder/transcoder 104. The content 130 may comprise for example, a program, a television show, a movie, a sports event broadcast, an advertisement or the like. The content 130 may comprise video frames or other images. For example, the content 130 may comprise video frames in a Moving Picture Experts Group (MPEG) Single Program Transport Stream (MPEG-SPTS). The video frames may comprise pixels. A pixel may comprise the smallest controllable element of a video frame. The video frame may comprise bits for controlling each associated pixel. A portion of the bits for an associated pixel may control a luma value (e.g., light intensity) of each associated pixel. A portion of the bits for an associated pixel may control one or more chrominance value (e.g., color) of the pixel.

The content source 102 may receive requests for the content 130 from the encoder/transcoder 104, the packager 106, the computing device 110, or the CDN 108. The content source 102 may send content 130 to the encoder/transcoder 104 based on a request for content from the encoder/transcoder 104, the packager 106, the computing device 110, or the CDN 108. The content 130 may comprise uncompressed video data or a content stream such as an MPEG-SPTS.

The encoder/transcoder 104 may comprise an encoder, which may encode uncompressed video data received from the content source 102. The terms transcoder and encoder may be used interchangeably herein. The terms transcode and encode may be used interchangeably herein. The encoder/transcoder 104 may receive content from the content source 102. The content may be in any one of a variety of formats, such as, for example, H.264, MPEG-4 Part 2, or MPEG-2. The encoder/transcoder 104 may convert the content from one video format to another video format, such as one format compatible with the playback devices of the service provider's users (e.g., computing device 110). The encoder/transcoder 104 may additionally segment the content into a plurality of segments.

When uncompressed video data is received, the encoder may encode the video (e.g., into a compressed format) using a compression technique prior to transmission. The content source 102 and the encoder/transcoder 104 may be co-located at a premises, located at separate premises, or associated with separate instances in the cloud. The encoder 104 may comprise any type of encoder including but not limited to: H.264/MPEG-AVC, H.265/MPEG-HEVC, MPEG-5 EVC, H.266/MPEG-VVC, AV1, VP9, Global motion compensation (GMC), etc. The encoder/transcoder 104 may transcode the content 130 into one or more output streams 140. The one or more output streams 140 may comprise video encoded with different resolutions and/or different bit rates.

The packager 106 may receive the content from the encoder/transcoder 104. For example, the packager 106 may receive the one or more output streams 140 from the encoder/transcoder 104. The packager 106 may determine how the content is to be segmented and put together for delivery to and eventual playback by the computing device 110. As part of this process, the packager 106 may segment the content (such as in the event that the content has not yet been segmented) or may re-segment the content (such as in the event that the content had been previously segmented). The packager 106 may additionally insert one or more cues or markers into the content segments at which one or more additional segments, such as segments comprising an advertisement, may be inserted by an upstream client, server, or logical module.

The packager 106 may create a manifest file associated with the content. For example, the manifest may comprise a DASH manifest. The manifest may comprise information describing various aspects of the associated content that may be useful for the computing device 110 to playback the content. For example, the manifest may indicate the availability of the segments comprising the content, the length of each segment, the number of segments, and/or the proper ordering of the segments necessary to cause playback of the content. The manifest may further include a network location (e.g., a hyper-text transfer protocol (HTTP) uniform resource locater (URL) link or other universal resource identifier (URI)) for each segment from which the segment may be downloaded, accessed, or retrieved.

The network locations included within the manifest may indicate more than one location or source. For example, the network location for segments corresponding to the content may reference a storage location while the network location for segments corresponding to an inserted advertisement may reference a location from outside the system 100 (e.g., at an advertising server). The manifest may describe multiple versions (e.g., different quality levels) of the content, including corresponding information on those segments. For example, manifest may describe multiple bit rate and/or resolution versions of the content. The manifest may be provided to the computing device 110 in response to a request to receive content. The computing device 110 may use the manifest file to determine the segments required to play the content or a segment/portion of the content and subsequently download the required segments using the network locations specified in the manifest file.

The packager 106 may generate one or more ABR streams 150 in different ABR streaming formats. The one or more ABR streams 150 may comprise segments or fragments of video and the manifest. The manifest may indicate availability of the ABR stream and segments/fragments and information for requesting the segments/fragments (e.g., via a URL). The packager 106 may send the one or more ABR streams 150 to the CDN 108.

The CDN 108 may comprise one or more computing devices such as servers 120A, 120B, 120C that store content (e.g., the one or more ABR streams 150). The CDN 108 may receive a request for content from the computing device 110. The request may be sent via HTTP. The CDN 108 may authorize/authenticate the request and/or the computing device 110 from which the request originated. The request for content may comprise a request for a channel, a recorded program, a video on-demand asset, a website address, a video asset associated with a streaming service, the like, and/or any combination of the foregoing. The CDN 108 may send the request to the content source 102, the encoder/transcoder 104, or the packager 106. The CDN 108 may send the requested content 160 to the computing device 110. The one or more servers 120A, 120B, 120C of the CDN 108 may serve the content 160 to the computing device 110.

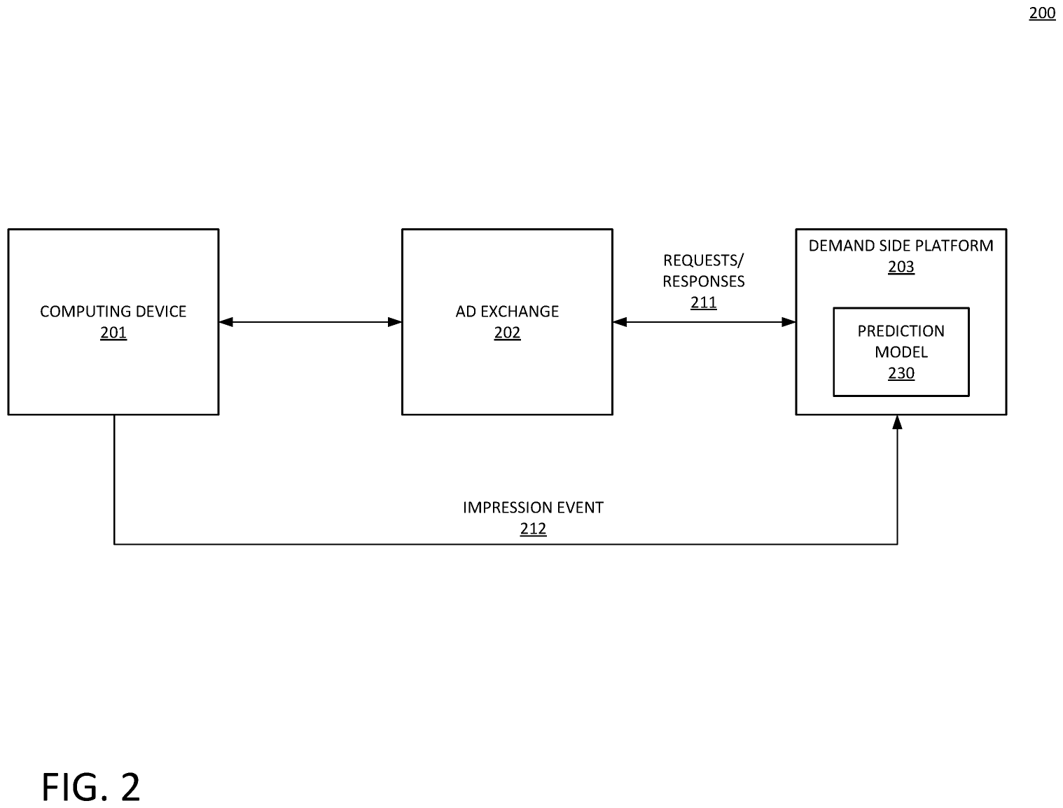

FIG. 2 shows an example system 200. The system 200 may comprise a computing device 201, advertising exchange 202, and a demand side platform 203. The computing device may comprise a user device capable of playing back content such as the computing device 110 of FIG. 1. The advertising exchange 202 may comprise, for example, a digital marketplace enabling advertisers to purchase impressions from a publisher (e.g., a content delivery service, streaming service, app, or website) selling advertising inventory (e.g., ad avails, insertion slots within a content stream, time slots within a content stream, a banner, a video, etc.). The demand side platform 203 may comprise a system or software enabling advertisers to purchase advertising inventory. The demand side platform 203 may automate the placement of bids, manage resources, and track impressions. The demand side platform 203 may send bid requests and receive bid responses 211 to/from the advertising exchange 202. Advertising content may be placed in inventory purchased by an advertiser via the demand side platform 230 resulting in an impression event 212 received from computing device 201.

The demand side platform 203 may comprise a prediction model 230 that may be used to predict whether a bid will be accepted or rejected and how long it will take to receive the impressions 212. The prediction model 230 may analyze historical data (e.g., a previous day's data) to predict whether a bid will be accepted or rejected and/or a number of delayed impressions. For example, the model 230 may determine the distribution of time between an impression and the bidding cycle.

Before sending a bid request 211 to the advertising exchange 202, the prediction model 230 may analyze features of the bid. Based on the features of the bid request, the prediction model 230 may determine which features impact whether an impression will be delayed. Based on the features of the bid request, the prediction model 230 may determine whether it is likely that the bid will be accepted or rejected, or whether the bidder expects to win or lose the bid. As described above, a delayed impression is an impression that is triggered after an inflight window expires. The inflight window is a time duration in which every bid is considered a winner. For example, the inflight window may be 30 seconds. An advertiser may bid on an advertisement placement opportunity (e.g., an ad avail) if the advertiser's allocated budget less their consumed budget and less their inflight budget is greater than the amount for the bid.

The prediction model 230 may execute one or more scripts to determine which features are more likely to lead to a delayed impression. The prediction model 230 may execute one or more scripts to determine whether the bid request is likely to be an accepted bid request or a rejected bid request. These determinations may be further based on historical data. The features may comprise, for example, information associated with the target audience such as geographic or demographic information, a device type of the device presenting the advertisement, an inventory source, a placement type, or an application bundle. The features may be determined, for example, based on populated fields in the bid request or based on metadata or other information associated with the bid request. For example, the inventory source may be determined based on based on metadata or other information associated with the bid request.

The prediction model 230 may determine a distribution associated with each feature of the bid. The distribution may indicate a percentage likelihood that the bid results in a delayed impression, an accepted bid request, or a rejected bid request. For example, the prediction model 230 may construct a feature tree to determine which distribution to use for determining the likelihood that the bid request is a winning bid or losing bid. For example, for each level in the tree, a distribution may be determined. For example, a distribution for a winning bid may be determined for all bids associated with a particular type of user device associated with the computing device 201 (e.g., whether computing device 201 comprises a mobile device, television, or PC). In another example, a distribution of winning bids may be determined for all bids associated with a particular application (e.g., streaming service or game) being executed by the computing device 201. In another example, a distribution of winning bids may be determined for all bids associated with a particular ad exchange (e.g., ad exchange 202).

For example, the prediction model 230 may construct a feature tree to determine which distribution to use for determining the likelihood that an impression from a winning bid associated with the bid request is delayed by a time duration. For example, for each level in the tree, a distribution may be determined. For example, a distribution of delayed impressions may be determined for all bids associated with a particular type of user device associated with the computing device 201 (e.g., whether computing device 201 comprises a mobile device, television, or PC). In another example, a distribution of delayed impressions may be determined for all bids associated with a particular application (e.g., streaming service or game) being executed by the computing device 201. In another example, a distribution of delayed impressions may be determined for all bids associated with a particular ad exchange (e.g., ad exchange 202).

For example, the prediction model 230 may determine, based on historical data, a cutoff portion of all placed bids within a particular time period. The cutoff portion may refer to the percentage of bids during the time period that result in an impression within 30 seconds, which indicates that the impression that is not delayed. The prediction model 230 may use the determined distributions, determined based on the analyzed feature tree, to determine a time duration for receiving delayed impressions associated with the bids remaining outside the cutoff portion. For example, the prediction model may determine a 50% cutoff portion indicating that 50% of bids would result in an impression within 30 seconds. The prediction model 230 may then determine that 80% of the remaining 50% of bids will result in delayed impressions received in a range of 30 seconds to 3 minutes, 10% of the remaining 50% of bids will result in delayed impressions received in a range of 3 minutes to 6 minutes, 5% of the remaining 50% of bids will result in delayed impressions received in a range of 6 minutes to 9 minutes, and the last 5% of the remaining 50% of bids will result in delayed impressions received in a range of 9 minutes to 12 minutes.

As a result, the prediction model 230 may predict whether a bid request is likely to be accepted or rejected and may predict delayed impressions and the amount of delay, and therefore may provide more accurate, real-time information about available resources (e.g., available budget) to an advertiser. For example, an advertiser may bid, via the demand side platform 203, on an advertisement placement opportunity (e.g., an ad avail) if the advertiser's allocated budget less their consumed budget, less their inflight budget, and less their delayed impression budget is greater than the amount for the bid.

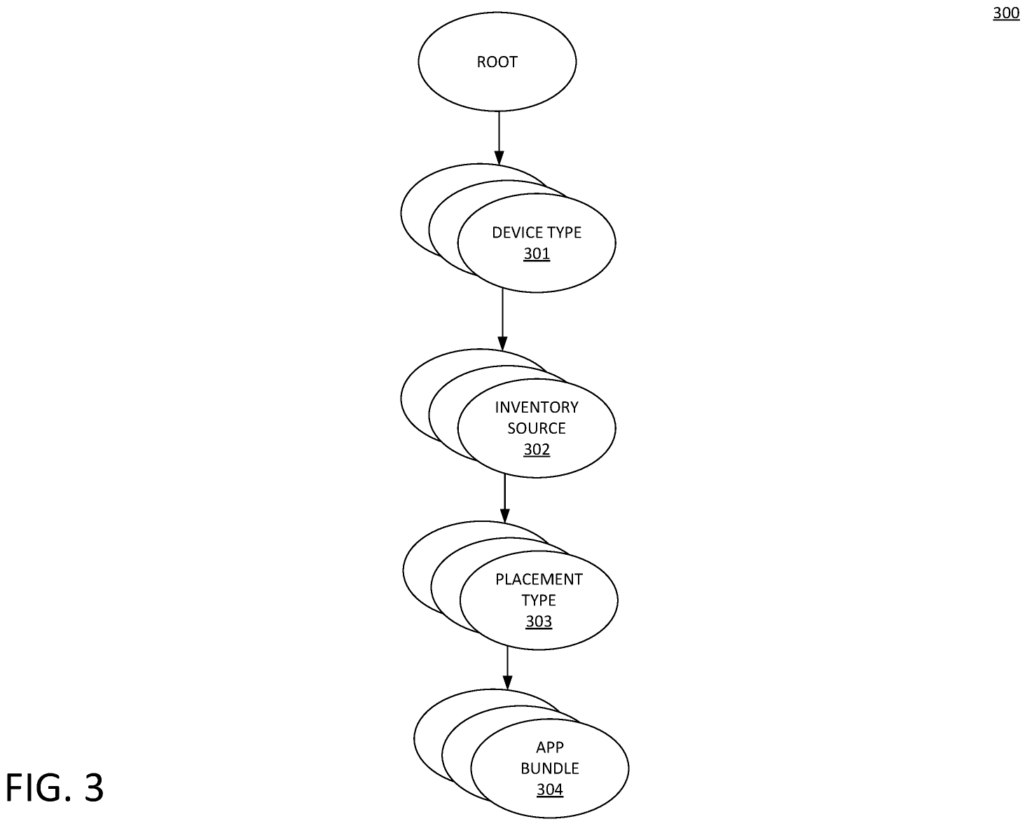

FIG. 3 shows feature tree categories 300. The example of FIG. 3 shows that the features analyzed by a prediction model, such as the prediction model 230 of FIG. 2, may comprise: a device type 301 of the device playing back the advertisement (e.g., a computing device, mobile device, PC, connected television, game console, or the like); inventory source 302 (e.g., a supply side platform (SSP)); a placement type 303 (e.g., banner, video, etc.); and an app bundle 304 (e.g., specific app id). The features may be determined, for example, based on populated fields in the bid request or based on metadata or other information associated with the bid request. For example, the inventory source 302 may be determined based on based on metadata or other information associated with the bid request.

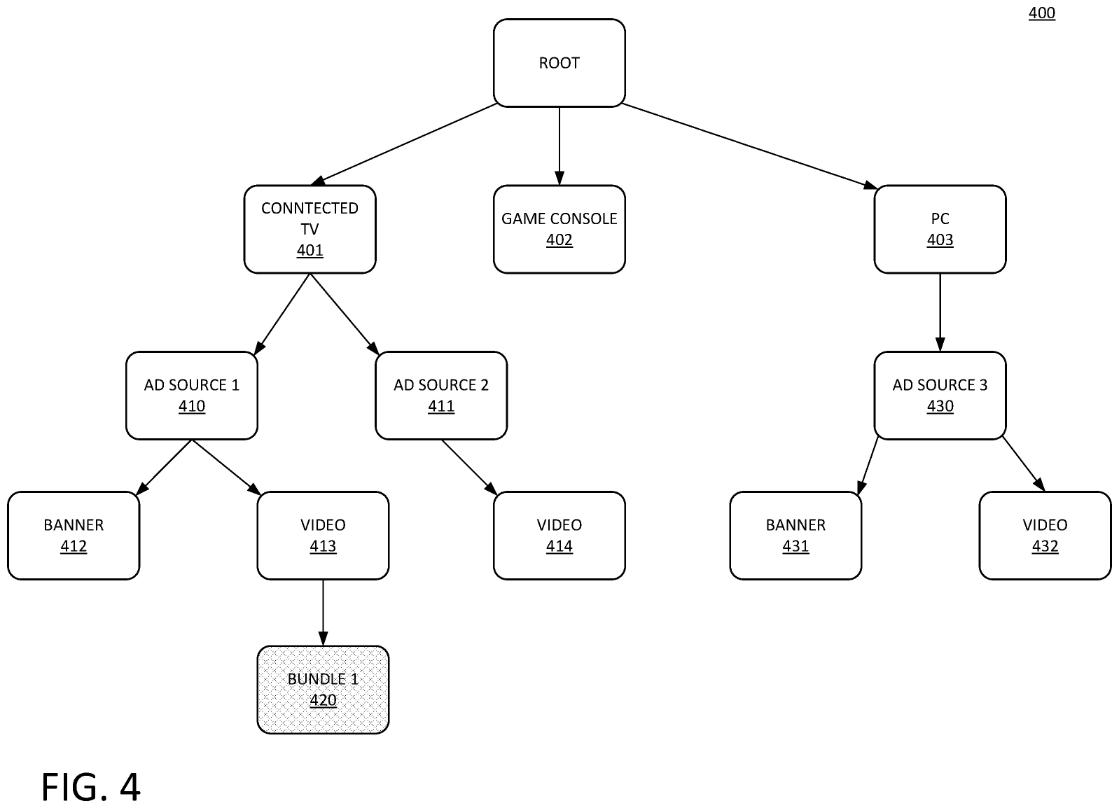

FIG. 4 shows an example feature tree 400 associated with a bid request. The bid request may indicate the following features: {Device Type: Connected TV, Inventory Source: Ad Source 1, Placement Type: Video, App Bundle: Bundle1, . . . }. As shown in the example of FIG. 4, the feature tree may indicate the types of device type: connected TV 401, game console 402, or PC 403. The bid request may also be associated with an inventory source such as ad source 1 410, ad source 2 411, or ad source 3 430. Each ad source may be associated with a placement type such as banner 412, 431 or video 413, 432. Each placement type may be associated with a specific application id. In the example of FIG. 4, the application id for the ad placement that is associated with the selected distribution is referred to as bundle 1 420.

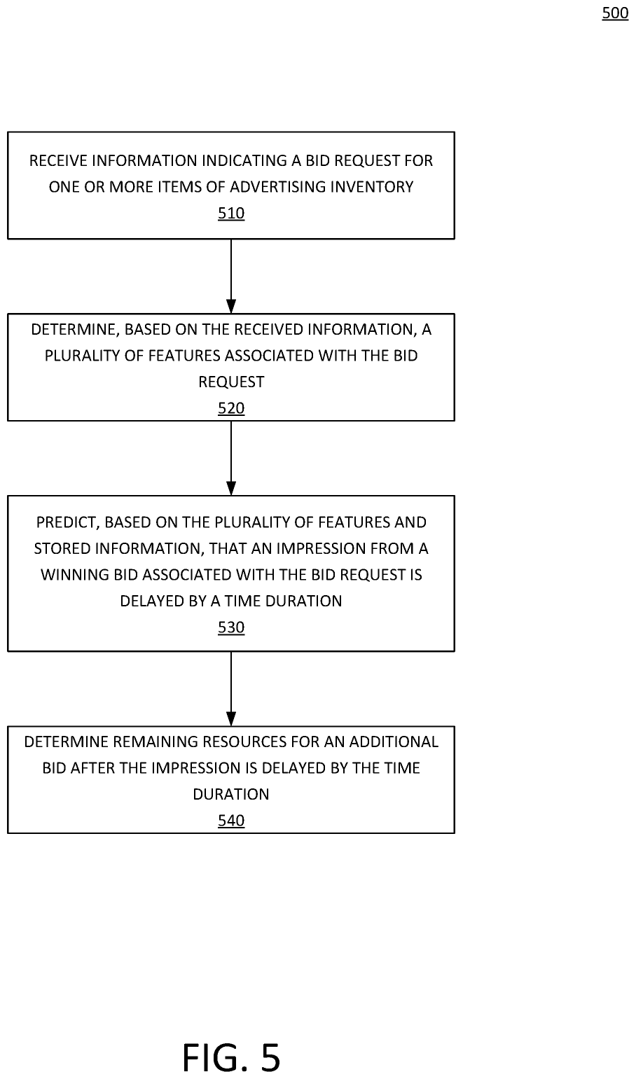

FIG. 5 shows an example method 500. The method 500 of FIG. 5, may be performed by any device, for example, by any of the devices depicted in FIGS. 1-2 or described herein. While each step in the method 500 of FIG. 5 is shown and described separately, multiple steps may be executed in a different order than what is shown, in parallel with each other, or concurrently with each other. At step 510, the system may receive information indicating a bid request for one or more items of advertising inventory. The information may be received from a computing device associated with a content source and via a demand side platform.

At step 520, the system may determine, based on the received information, a plurality of features associated with the bid request. The plurality of features may comprise at least one of: information associated with a target audience such as geographic or demographic information, a device type of a computing device presenting advertising content associated with the bid request, an inventory source, a placement type, or an application bundle. Each feature of the plurality of features may be associated with a distribution indicating a percentage likelihood that the impression from the winning bid associated with the bid request is delayed by the time duration. The determining the plurality of features may comprise executing one or more scripts. The one or more scripts may output one or more indications of which features of the plurality of features impact whether an impression event will be delayed.

Determining the plurality of features may comprise generating, based on the received information, a tree comprising the plurality of features. Each level of the tree may condition a distribution on an additional feature of the plurality of features.

At step 530, the system may predict, based on the plurality of features and stored information, that an impression from a winning bid associated with the bid request is delayed by a time duration. The stored information may comprise historical data associated with at least one of: an inventory source, a device type of a computing device presenting advertising content, a target audience, an inventory source, a placement type, or an application bundle. The delayed impression may comprise an impression event that is triggered after an inflight window expires. The inflight window may comprise a time duration in which every bid submitted is considered a winner.

At step 540, the system may determine remaining resources for an additional bid after the impression is delayed by the time duration. The remaining resources may indicate that an allocated budget less a consumed budget, less an inflight budget, and less a delayed impression budget is greater than an amount for the bid request. The system may receive data indicating an impression event associated with the delayed impression.

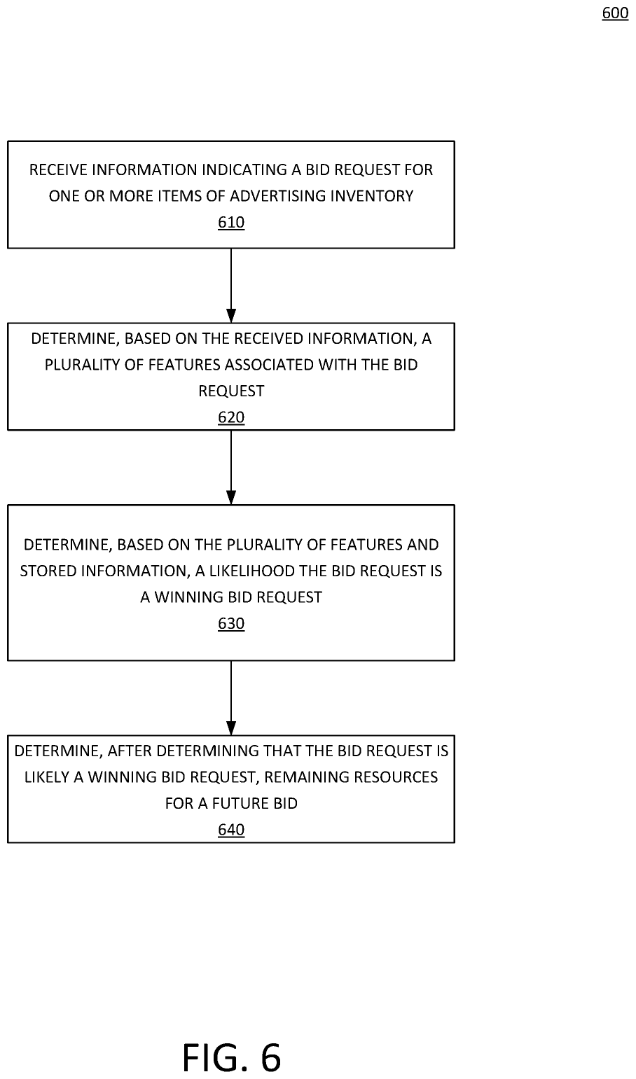

FIG. 6 shows an example method 600. The method 600 of FIG. 6, may be performed by any device, for example, by any of the devices depicted in FIGS. 1-2 or described herein. While each step in the method 600 of FIG. 6 is shown and described separately, multiple steps may be executed in a different order than what is shown, in parallel with each other, or concurrently with each other. At step 610, the system may receive information indicating a bid request for one or more items of advertising inventory. The information may be received from a computing device associated with a content source and via a demand side platform.

At step 620, the system may determine, based on the received information, a plurality of features associated with the bid request. The plurality of features may comprise at least one of: information associated with a target audience such as geographic or demographic information, a device type of a computing device presenting advertising content associated with the bid request, an inventory source, a placement type, or an application bundle. Each feature of the plurality of features may be associated with a distribution indicating a percentage likelihood that the bid request is a winning bid. Each level of the tree may condition a distribution on an additional feature of the plurality of features. Generating the tree may comprise executing one or more scripts. The one or more scripts may output one or more indications of which features of the plurality of features impact whether an impression event will be a winning bid.

At step 630, the system may determine, based on the plurality of features and stored information, a likelihood the bid request is a winning bid request. The stored information may comprise historical data associated with at least one of: an inventory source, a device type of a computing device presenting advertising content, a target audience, an inventory source, a placement type, or an application bundle. The winning bid request may be indicated by an impression event that is triggered.

At step 640, the system may determine, after determining that the bid request is likely a winning bid request, remaining resources for a future bid. The remaining resources may indicate that an allocated budget less a consumed budget, less an inflight budget, and less a delayed impression budget is greater than an amount for the bid request. The system may receive data indicating an impression event associated with the winning bid request.

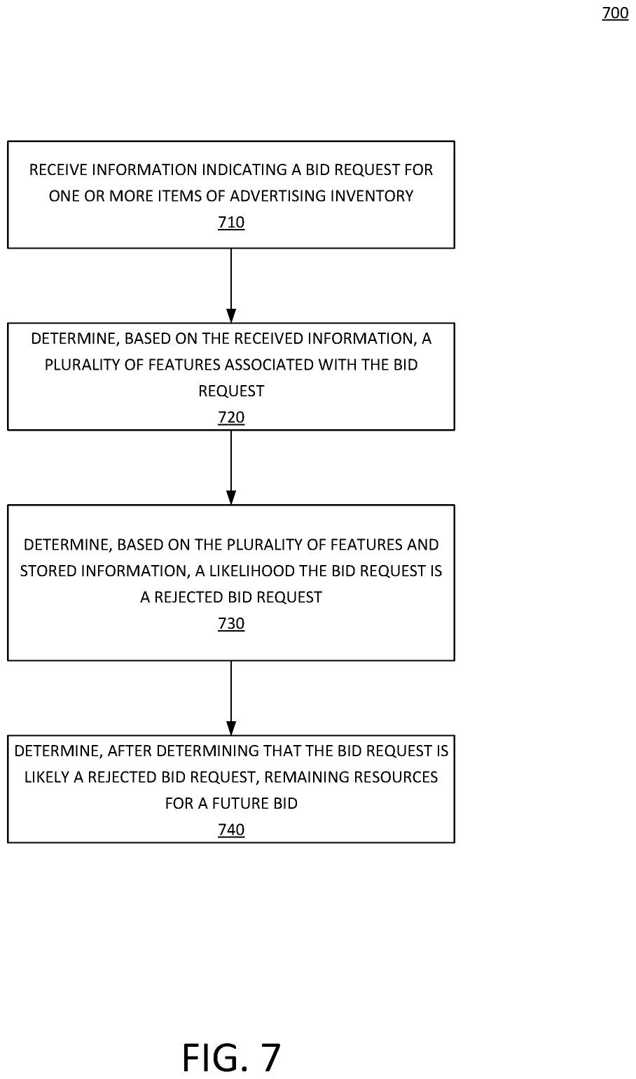

FIG. 7 shows an example method 700. The method 700 of FIG. 7, may be performed by any device, for example, by any of the devices depicted in FIGS. 1-2 or described herein. While each step in the method 700 of FIG. 7 is shown and described separately, multiple steps may be executed in a different order than what is shown, in parallel with each other, or concurrently with each other. At step 710, the system may receive information indicating a bid request for one or more items of advertising inventory. The information may be received from a computing device associated with a content source and via a demand side platform.

At step 720, the system may determine, based on the received information, a plurality of features associated with the bid request. The plurality of features may comprise at least one of: information associated with a target audience such as geographic or demographic information, a device type of a computing device presenting advertising content associated with the bid request, an inventory source, a placement type, or an application bundle. Each feature of the plurality of features may be associated with a distribution indicating a percentage likelihood that the bid request is a winning bid. Each level of the tree may condition a distribution on an additional feature of the plurality of features. Generating the tree may comprise executing one or more scripts. The one or more scripts may output one or more indications of which features of the plurality of features impact whether an impression event will be a winning bid.

At step 730, the system may determine, based on the plurality of features and stored information, a likelihood the bid request is a rejected bid request. The stored information may comprise historical data associated with at least one of: an inventory source, a device type of a computing device presenting advertising content, a target audience, an inventory source, a placement type, or an application bundle.

At step 740, the system may determine, after determining that the bid request is likely a rejected bid request, remaining resources for a future bid. The remaining resources may indicate that an allocated budget less a consumed budget, less an inflight budget, and less a delayed impression budget is greater than an amount for the bid request.

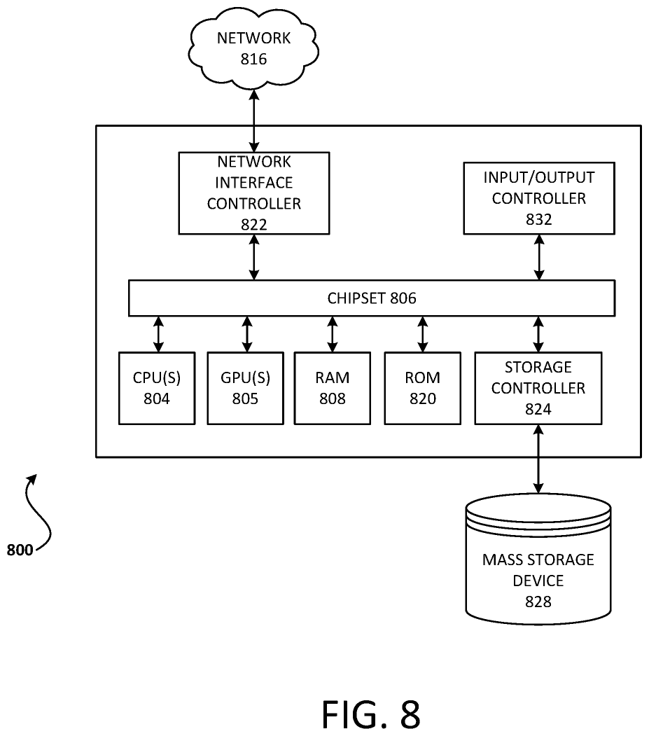

FIG. 8 depicts a computing device that may be used in various aspects, such as the servers, modules, and/or devices depicted in FIGS. 1-4. With regard to the example architecture of FIGS. 1-4, each device depicted in FIGS. 1-4 may be implemented in an instance of a computing device 800 of FIG. 8. The computer architecture shown in FIG. 8 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 1-7.

The computing device 800 may comprise a baseboard, or “motherboard,” which is a printed circuit board to which a multitude of components or devices may be connected by way of a system bus or other electrical communication paths. One or more central processing units (CPUs) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s) 805. The GPU(s) 805 may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random access memory (RAM) 808 used as the main memory in the computing device 800. The chipset 806 may provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems through local area network (LAN) 816. The chipset 806 may include functionality for providing network connectivity through a network interface controller (NIC) 822, such as a gigabit Ethernet adapter. A NIC 822 may be capable of connecting the computing device 800 to other computing nodes over a network 816. It should be appreciated that multiple NICs 822 may be present in the computing device 800, connecting the computing device to other types of networks and remote computer systems.

The computing device 800 may be connected to a mass storage device 828 that provides non-volatile storage for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may read information from the mass storage device 828 by detecting the physical states or characteristics of one or more particular locations within the physical storage units.

In addition to the mass storage device 828 described herein, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described herein. The computing device 800 may have access to computer-readable storage media storing computer-executable instructions, which, when executed by the computing device 800, may perform the methods described in relation to FIGS. 1-7.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes¬ from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
receiving information indicating a bid request for one or more items of advertising inventory;
determining, based on the received information, a plurality of features associated with the bid request;
predicting, based on the plurality of features and stored information, that an impression from a winning bid associated with the bid request is estimated to be delayed by a time duration;
determining remaining resources in an allocated budget for the bid request after the impression is estimated to be delayed by the time duration; and
providing, for transmission to an advertising exchange, the bid request based on the remaining resources in the allocated budget to enable an advertiser to bid on an advertisement placement opportunity associated with the bid request.

2. The method of claim 1, wherein the plurality of features comprises at least one of: information associated with a target audience such as geographic or demographic information, a device type of a computing device presenting advertising content associated with the bid request, an inventory source, a placement type, or an application bundle.

3. The method of claim 1, wherein the determining the plurality of features comprises generating, based on the received information, a tree comprising the plurality of features.

4. The method of claim 3, wherein each level of the tree conditions a distribution on an additional feature of the plurality of features, wherein each distribution indicates a percentage likelihood that an impression from the winning bid associated with the bid request is delayed by the time duration.

5. The method of claim 1, wherein each feature of the plurality of features is associated with a distribution indicating a percentage likelihood that the impression from the winning bid associated with the bid request is delayed by the time duration.

6. The method of claim 1, wherein the determining the plurality of features comprises executing one or more scripts, wherein the one or more scripts output one or more indications of which features of the plurality of features impact whether an impression event will be delayed.

7. The method of claim 1, wherein the stored information comprises historical data associated with at least one of: an inventory source, a device type of a computing device presenting advertising content, a target audience, a placement type, or an application bundle.

8. The method of claim 1, wherein the receiving the information is from a computing device associated with a content source and via a demand side platform.

9. The method of claim 1, wherein the impression comprises an impression event that is triggered after an inflight window expires, wherein the inflight window comprises a time duration in which every bid submitted is considered a winner.

10. The method of claim 1, wherein the remaining resources in the allocated budget is greater than a budget amount for the bid request, wherein the remaining resources in the allocated budget correspond to the allocated budget less a consumed budget, less an inflight budget, and less a delayed impression budget.

11. The method of claim 1, further comprising:
receiving data indicating an impression event associated with the impression delayed by the time duration.

12. A method comprising:
receiving information indicating a bid request for one or more items of advertising inventory;
determining, based on the received information, a plurality of features associated with the bid request;
determining, based on the plurality of features and stored information, a likelihood that the bid request is a winning bid request and a likelihood that the bid request is associated with a delayed impression of the winning bid request;
determining, based on the likelihood that the bid request is a winning bid request and the likelihood that the bid request is associated with a delayed impression of the winning bid request, remaining resources in an allocated budget for the bid request; and
providing, for transmission to an advertising exchange, the bid request based on the remaining resources in the allocated budget to enable an advertiser to bid on an advertisement placement opportunity associated with the bid request.

13. The method of claim 12, wherein the plurality of features comprises at least one of: information associated with a target audience such as geographic or demographic information, a device type of a computing device presenting advertising content associated with the bid request, an inventory source, a placement type, or an application bundle.

14. The method of claim 12, wherein the determining the plurality of features comprises:
generating, based on the received information, a tree comprising the plurality of features wherein the generating the tree comprises executing one or more scripts, wherein the one or more scripts output one or more indications of which features of the plurality of features impact whether an impression event will be a winning bid.

15. The method of claim 12, wherein the stored information comprises historical data associated with at least one of: an inventory source, a device type of a computing device presenting advertising content, a target audience, a placement type, or an application bundle.

16. The method of claim 12, wherein the winning bid request is indicated by an impression event.

17. The method of claim 12, wherein the remaining resources in the allocated budget is greater than a budget amount for the bid request, wherein the remaining resources in the allocated budget correspond to the allocated budget less a consumed budget, less an inflight budget, and less a delayed impression budget.

18. A method comprising:
receiving information indicating a bid request for one or more items of advertising inventory;
determining, based on the received information, a plurality of features associated with the bid request;
determining, based on the plurality of features and stored information, a likelihood that the bid request is a rejected bid request and a likelihood that the bid request is associated with a delayed impression of the rejected bid request;
determining, based on the likelihood that the bid request is a rejected bid request and the likelihood that the bid request is associated with a delayed impression of the rejected bid request, remaining resources in an allocated budget for the bid request; and
providing, for transmission to an advertising exchange, the bid request based on the remaining resources in the allocated budget to enable an advertiser to bid on an advertisement placement opportunity associated with the bid request.

19. The method of claim 18, wherein the determining the plurality of features comprises:
generating, based on the received information, a tree comprising the plurality of features wherein the generating the tree comprises executing one or more scripts, wherein the one or more scripts output one or more indications of which features of the plurality of features impact whether an impression event will be a rejected bid.

20. The method of claim 18, wherein the plurality of features comprises at least one of: information associated with a target audience such as geographic or demographic information, a device type of a computing device presenting advertising content associated with the bid request, an inventory source, a placement type, or an application bundle.
